(19) United States
(12) Patent Application Publication
(10) Pub. No.: US 2022/0317607 A1
(43) Pub. Date: Oct. 6, 2022

(54) FIXING DEVICE AND IMAGE FORMING APPARATUS

(71) Applicant: KYOCERA Document Solutions Inc., Osaka (JP)

(72) Inventors: Tomohiro WATATANI, Osaka-shi (JP); Yuhiro SAKAI, Osaka-shi (JP); Takashi EIKI, Osaka-shi (JP); Ryohei TOKUNAGA, Osaka-shi (JP); Akihiro KONDO, Osaka-shi (JP); Yuta KITABAYASHI, Osaka-shi (JP); Rina KIKUGAWA, Osaka-shi (JP); Hiroki KAWASAKI, Osaka-shi (JP); Shunsaku FUJII, Osaka-shi (JP); Tei TO, Osaka-shi (JP)

(73) Assignee: KYOCERA Document Solutions Inc., Osaka (JP)

(21) Appl. No.: 17/704,668

(22) Filed: Mar. 25, 2022

(30) Foreign Application Priority Data
Mar. 30, 2021 (JP) 2021-057953
Mar. 30, 2021 (JP) 2021-057954

(51) Int. Cl. G03G 15/20; G03G 15/00

(52) U.S. Cl. CPC G03G 15/2053; G03G 15/5004; G03G 15/5045

(57) ABSTRACT

A temperature detection section is disposed opposite to a heater so as to be out of contact with the heater, and detects a temperature of the heating element. A spacer is disposed so that the heater and the temperature detection section are out of contact with each other. The spacer includes a separator that separates the temperature detection section from the heater and that has a gap through which the heat is transferred from the heater to the temperature detection section and that melts upon the temperature of the heating element increasing to a specific temperature or higher. The separator after melting fills the gap.

### INCORPORATION BY REFERENCE

The present application claims priority under 35 U.S.C. § 119 to Japanese Patent Applications No. 2021-057953 and No. 2021-057954, each filed on Mar. 30, 2021. The contents of these applications are incorporated herein by reference in their entirety.

### BACKGROUND

The present disclosure relates to a fixing device and an image forming apparatus.

A typical fixing device includes a spacer between a heater and a peripheral member.

### SUMMARY

A fixing device according to an aspect of the present disclosure includes a fixing belt and a heater. The fixing belt heats a sheet with the toner image formed thereon. The heater heats the fixing belt. The heater includes a heating element, a temperature detection section, and a spacer. The heating element generates heat by energization. The temperature detection section is disposed out of contact with the heater and opposite to the heater, and detects a temperature of the heating element. The spacer is disposed between the heater and the temperature detection section so that the heater and the temperature detection section are out of contact with each other. The spacer separates the temperature detection section from the heater, and includes a separator that has a gap through which the heat is transferred from the heater to the temperature detection section and that melts upon the temperature of the heating element increasing to a specific temperature or higher. The separator after melting fills the gap.

### BRIEF DESCRIPTION OF THE DRAWINGS

FIG. 1 is a diagram illustrating a multifunction peripheral including a fixing device and an image forming apparatus according to an embodiment of the present disclosure.

FIG. 2 is a block diagram of a configuration of the image forming apparatus that includes the fixing device of the embodiment.

FIG. 3 is an external perspective view of a configuration of the fixing device according to the embodiment.

FIG. 4 is an external perspective view of the configuration of the fixing device of the embodiment.

FIG. 5 is a side view of the configuration of the fixing device of the embodiment.

FIG. 6 is a cross sectional view taken along a line VI-VI in FIG. 5.

FIG. 7 is an external perspective view of the configuration of main components of the fixing device of the embodiment.

FIG. 8 is an external perspective view of a configuration of each main component of the fixing device of the embodiment.

FIG. 9 is an enlarged view of an area A in FIG. 8.

FIGS. 10A to 10D each illustrate a temperature detection section and a spacer.

FIG. 11 is a cross sectional view taken along a line XI-XI in FIG. 9.

FIGS. 12A to 12F each are a diagram explaining change of the spacer.

FIGS. 13A to 13F each are a diagram explaining change of the spacer.

FIG. 14 is a diagram illustrating a configuration of the temperature detection section.

FIGS. 15A and 15B each are a diagram illustrating an example of the spacer.

FIG. 16 is a diagram illustrating a configuration of a separator and a facing surface of a heat sensitive part.

FIG. 17 is a graph representation showing a relationship between a ratio and the amount of temperature drop.

FIG. 18 is a graph representation showing a relationship between the thickness of the spacer and the ratio.

FIG. 19 is a graph representation showing a relationship between the volume of the separator and the area of the separator after melting.

### DETAILED DESCRIPTION

The following describes an embodiment of the present disclosure with reference to the accompanying drawings. Note that elements that are the same or equivalent are indicated by the same reference signs in the drawings and description thereof is not repeated. In the drawings, an X axis, a Y axis, and a Z axis that are perpendicular to one another are indicated as appropriate. The Z axis is parallel to the vertical direction, and the X axis and the Y axis are parallel to a horizontal plane.

In the present embodiment, The Y-axis direction may be referred to as “main scanning direction”. Also, the Z-axis direction may be referred to as “sub-scanning direction”. The X-axis direction may be referred to as “direction perpendicular to the main scanning direction and the sub-scanning direction”.

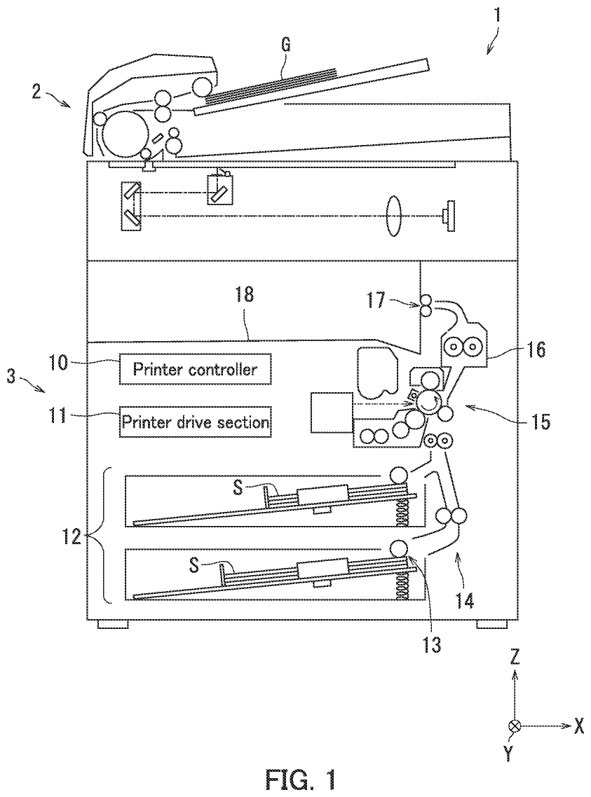

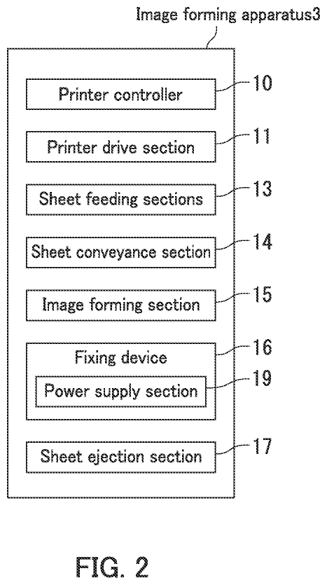

With reference to FIG. 1, the configuration of a multifunction peripheral 1 will be described. FIG. 1 is a diagram illustrating the multifunction peripheral 1 including a fixing device 16 according to the present embodiment. Also, the configuration of an image forming apparatus 3 that includes the fixing device 16 according to the present embodiment will be described with reference to FIG. 2. FIG. 2 is a block diagram of the configuration of the image forming apparatus 3 that includes the fixing device 16 of the embodiment.

As illustrated in FIGS. 1 and 2, the multifunction peripheral 1 includes a document reading device 2 and an image forming apparatus 3. The multifunction peripheral 1 is a multifunction peripheral (MFP) having functions of a scanner, a copier, a printer, and a facsimile machine, and a function other than these, for example.

The document reading device 2 includes a document tray, a document feed section, a document conveyance section, a document reading section, an optical member, a document exit section, and a document exit tray, for example.

The image forming apparatus 3 includes a printer controller 10, a printer drive section 11, sheet trays 12, sheet feeding sections 13, a sheet conveyance section 14, an image forming section 15, a fixing device 16, a sheet ejecting section 17, and a sheet exit tray 18.

The printer controller 10 controls operation of each element of the image forming apparatus 3. The printer controller 10 may function as a controller for controlling operation of each element of the multifunction peripheral 1. Specific examples of the printer controller 10 includes a central processing unit (CPU), a micro-processing unit (MPU), and an application specific integrated circuit (ASIC).

The printer controller 10 selects a size of a sheet S passing through the fixing device 16. The printer controller 10 selects a size of the sheet S based on a job instruction and specifies one of the sheet feeding sections 13 according to the size of the sheet S to be fed therefrom.

The printer drive section 11 drives each element of the image forming apparatus 3. The printer drive section 11 may be a drive section that operates each element of the multifunction peripheral 1. Specific examples of the printer drive section 11 include an electric motor, an electromagnetic solenoid, a hydraulic cylinder, and an air pressure cylinder.

Sheets S are stacked on each of the sheet trays 12. Each sheet S is an example of a recording medium. The sheet trays 12 may each include a tray and a raising and lowering member. The sheet feeding sections 13 each pick up and feed the sheet S stacked on a corresponding one of the sheet trays 12 one at a time. A specific example of each sheet feeding section 13 is a pickup roller.

The sheet conveyance section 14 conveys the sheet S fed from either of the sheet trays 12. The sheet conveyance section 14 forms a conveyance path. The conveyance path extends from each sheet tray 12 as a starting point to the sheet ejecting section 17 via the image forming section 15 and the fixing device 16. The sheet conveyance section 14 may include conveyance rollers and a registration roller at the conveyance path.

The conveyance rollers may be disposed at the conveyance path to convey the sheet S. The registration roller adjusts the timing at which the sheet S is conveyed to the image forming section 15. The sheet conveyance section 14 conveys the sheet S from the sheet tray 12 to the sheet ejecting section 17 via the image forming section 15 and the fixing device 16.

The image forming section 15 electrographically forms a non-illustrated toner image on the sheet S based on document image data. The document image data indicates an image of a document G, for example.

The fixing device 16 applies heat and pressure to the toner image developed on the sheet S to fix the toner image to the sheet S. The fixing device 16 includes a power supply section 19. The power supply section 19 will be described later.

The sheet ejecting section 17 ejects the sheet out of the casing of the multifunction peripheral 1 (image forming apparatus 3). A specific example of the sheet ejecting section 17 is an ejection roller.

The sheets S ejected by the sheet ejecting section 17 are stacked on the sheet exit tray 18.

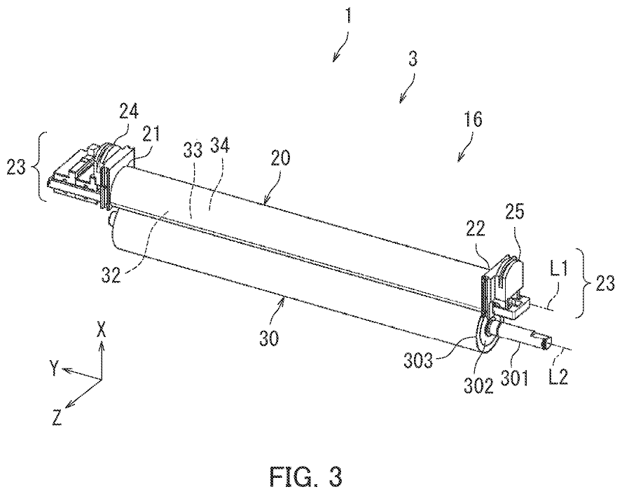

The configuration of the fixing device 16 according to the present embodiment will be described next in detail with reference to FIGS. 3 to 13.

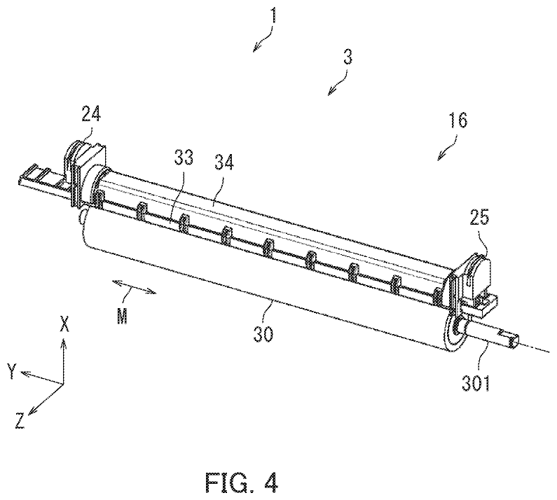

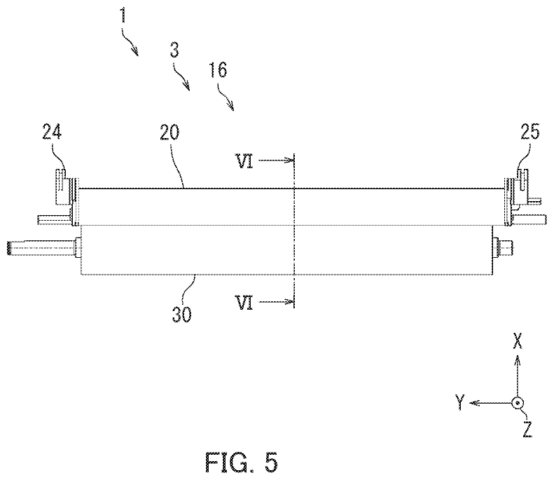

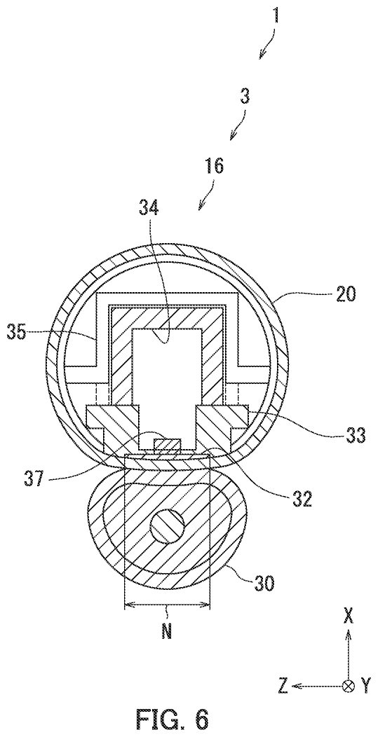

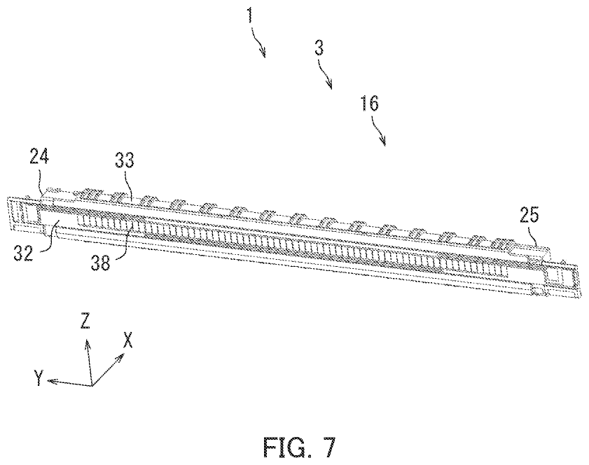

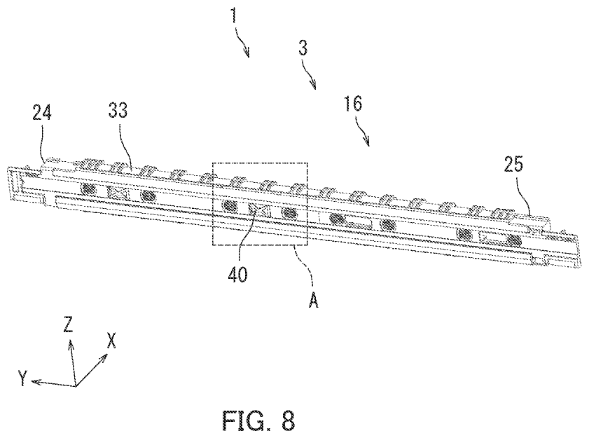

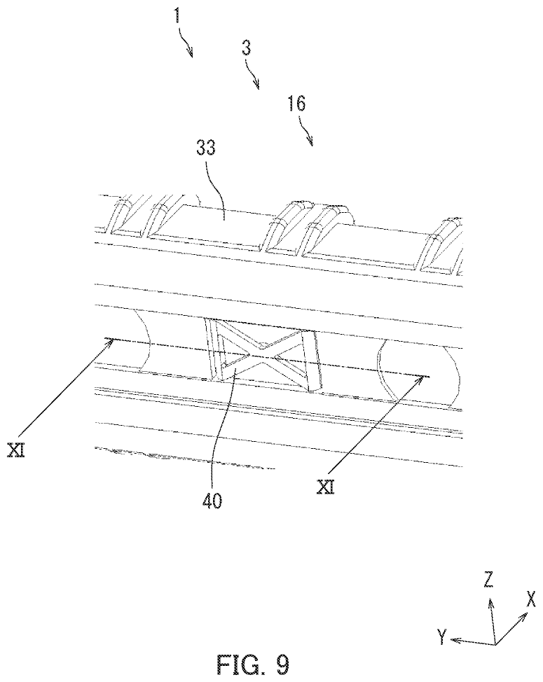

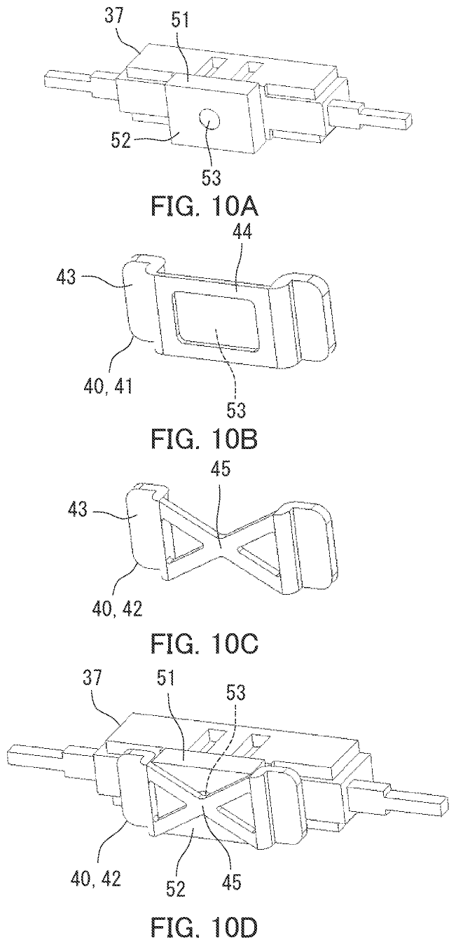

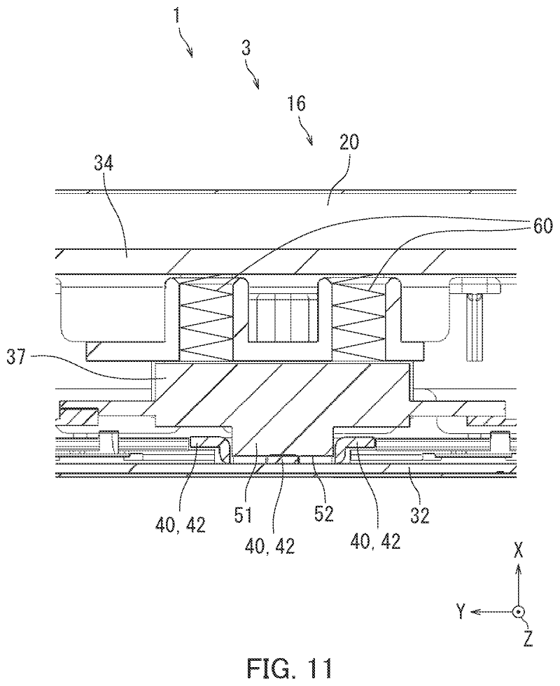

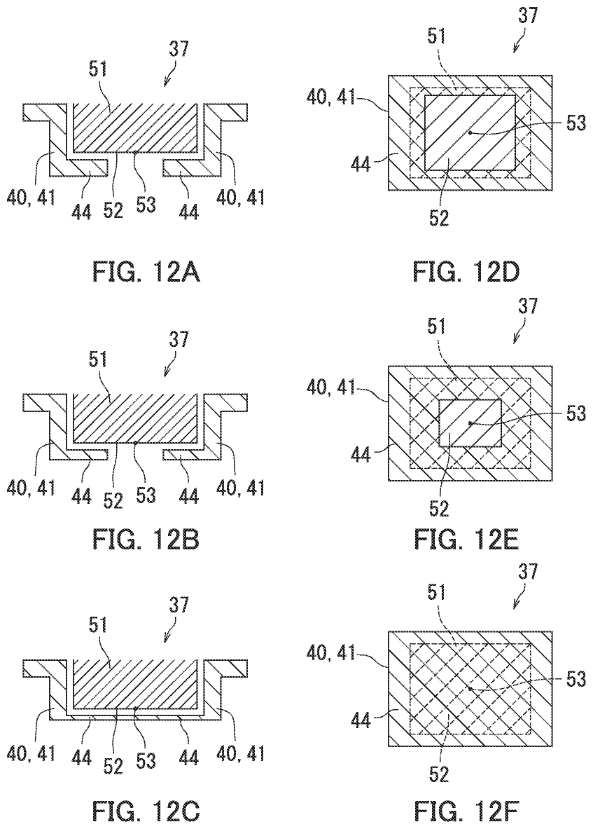

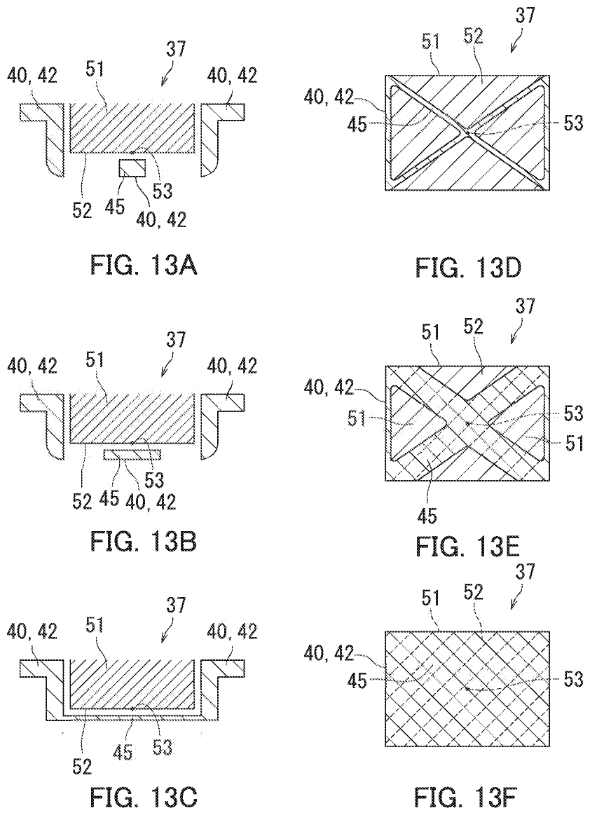

FIGS. 3 and 4 each are an external perspective view of the configuration of the fixing device 16 of the present embodiment. FIG. 5 is a side view of the configuration of the fixing device 16 of the present embodiment. FIG. 6 is a cross sectional view taken along a line VI-VI in FIG. 5. FIGS. 7 and 8 each are an external perspective view of each configuration of main components of the fixing device 16 of the embodiment. FIG. 9 is an enlarged view of an area A in FIG. 8. FIG. 10A illustrates a temperature detection section 37, and FIGS. 10B to 10D each illustrate a spacer 40. FIG. 11 is a cross sectional view taken along a line XI-XI in FIG. 9. FIGS. 12A to 12F and 13A to 13F are diagrams explaining change of the spacer 40 (spacer 41, spacer 42).

As illustrated in FIGS. 3 to 6 and 11, the fixing device 16 includes a power supply section 19, a fixing belt 20, an end 21, an end 22, a belt holding member 23 including a first belt holding member 24 and a second belt holding member 25, a pressure roller 30, a heater 32, a heater holding member 33, a frame stay metal plate 34, and an urging member 60.

The fixing belt 20 heats the sheet S with the toner image formed thereon. The fixing belt 20 fixes the toner image to the sheet S by heating the sheet S on which the toner image has been formed in the image forming section 15 in FIG. 1 and which has been conveyed to the fixing device 16.

As illustrated in FIGS. 3, 5, and 6, the fixing belt 20 is an endless belt. The fixing belt 20 has a substantially cylindrical shape. The fixing belt 20 is flexible. The fixing belt 20 is rotatable about a first rotation axis L1 as an axis thereof. The fixing belt 20 extends in a direction of the first rotation axis L1.

As illustrated in FIG. 3, the end 21 and the end 22 are the opposite ends of the fixing belt 20 in the direction of the first rotation axis L1. In the following, the direction of the first rotation axis L1 may be referred to as “rotation axis direction”, “rotation axis direction of the fixing belt 20”, or “width direction of the fixing belt 20”.

The fixing belt 20 includes a plurality of non-illustrated layers. The fixing belt 20 includes a polyimide layer and a release layer, for example. The release layer is formed on the outer circumferential surface of the polyimide layer. The release layer is a heat-resistant film made from fluororesin, for example.

As illustrated in FIG. 3, the belt holding member 23 holds the fixing belt 20 in a rotatable manner. The belt holding member 23 holds the end 21 and the end 22 of the fixing belt 20 in the rotation axis direction (direction of the first axial direction L1) of the fixing belt 20 in a rotatable manner.

The belt holding member 23 includes a first belt holding member 24 and a second belt holding member 25. The first belt holding member 24 holds the end 21 of the fixing belt 20 in a rotatable manner. The second belt holding member 25 holds the end 22 of the fixing belt 20 in a rotatable manner.

The pressure member 30 rotates while in close contact with the fixing belt 20 to apply pressure to the fixing belt 20. The pressure member 30 has a substantially columnar shape, and is disposed opposite to the fixing belt 20. An example of the pressure member 30 is a pressure roller 30. In the following, the pressure member 30 may be referred to as pressure roller 30.

The pressure roller 30 is rotatable about a second rotation axis L2 as an axis thereof. The pressure roller 30 extends in a direction of the second rotation axis L2. Note that the second rotation axis L2 is substantially parallel to the first rotation axis L1.

As illustrated in FIG. 6, when the pressure roller 30 applies pressure to the fixing belt 20, the heater 32 held by the heater holding member 33 located inside the fixing belt 20 comes contact with the fixing belt 20. Accordingly, the fixing belt 20 is heated by the heater 32.

As illustrated in FIG. 3, the pressure roller 30 includes a columnar metal core shaft 301, a cylindrical elastic layer 302, and a release layer 303. The elastic layer 302 is formed on the metal core shaft 301. The release layer 303 is formed to cover the surface of the elastic layer 302.

The metal core shaft 301 is rotatable about the second rotation axis L2 as an axis thereof. The metal core shaft 301 is made from stainless steel or aluminum, for example. The elastic layer 302 is elastic, and made from for example silicone rubber. The release layer 303 is made from fluororesin, for example.

As illustrated in FIG. 6, the heater 32 is connected to a non-illustrated power source, and generates heat. The heater 32 heats the fixing belt 20. As illustrated in FIG. 3, the heater 32 extends in the direction of the first rotation axis L1. The heater 32 is a surface heater or a thin and long plate-shaped heater, for example. For example, the heater 32 is a ceramic heater and includes a ceramic substrate and a resistance heating element. The heater 32 has a thickness of 1 mm, for example. The heater 32 receives pressure from the pressure member 30 via the fixing belt 20.

As illustrated in FIG. 6, the heater 32 is disposed opposite to the inner circumferential surface of the fixing belt 20. As illustrated in FIG. 11, the heater 32 is pressed toward the inner circumferential surface of the fixing belt 20 together with the heater holding member 33 by the frame stay metal plate 34 urged through the first belt holding member 24 and the second belt holding member 25.

As illustrated in FIG. 6, as a result of the pressure roller 30 pressing the fixing belt 20, a nip part N is formed at a contact part between the fixing belt 20 and the pressure roller 30. As a result of the pressure roller 30 pressing the fixing belt 20, the heater 32 is in contact with the inner circumferential surface of the fixing belt 20. Accordingly, the fixing belt 20 is heated by the heater 32 to fix to the sheet S the toner image formed on the sheet S (FIG. 1) passing through the nip part N.

Lubricant oil is applied onto the inner circumferential surface of the fixing belt 20. The lubricant oil is present between the fixing belt 20 and the heater 32. The lubricant oil forms an oil film between the heater 32 and the inner circumferential surface of the fixing belt 20. The lubricant oil reduces friction between the fixing belt 20 and the heater 32.

An example of the lubricant oil is grease. The grease has higher viscosity and lower fluidity than oil. As such, the grease is semi-solid or semi-fluid at room temperature. An example of the grease is a grease in a semi-solid state or a solid state obtained by uniformly dispersing a thickener containing for example calcium, sodium, lithium, aluminum or soap (salt of fatty acid) in a lubricant oil in a liquid state.

As illustrated in FIGS. 7 to 11, the heater 32 includes a heating element 38 on a facing surface thereof that faces the fixing belt 20. The urging member 60 urges the spacer 40 from the opposite surface of the heater 32 that is opposite to the facing surface thereof facing the fixing belt 20, and presses the temperature detection section 37 through the spacer 40.

The heating element 38 is energized by electric power supplied from a non-illustrated power source to generate heat.

The temperature detection section 37 is disposed out of contact with the heating element 38 and opposite to the heating element 38, and detects the temperature of the heating element 38.

The temperature detection section 37 may be a thermistor. An example of the thermistor is a positive temperature coefficient (PTC) thermistor. The PTC thermistor has a resistance that rapidly increases upon an increase in temperature thereof to a specific temperature or higher. As such, the PTC thermistor suppresses overcurrent to suppress an excessive temperature increase of the heating element 38.

The thermistor can favorably detect an excessive temperature increase of the heating element 38 in the present embodiment, thereby enabling favorable reduction of power supply to the heating element 38.

The temperature detection section 37 may be a thermostat. The thermostat cuts off power supply to the heating element 38 when the temperature thereof reaches a predetermined temperature or higher.

An example of the thermostat is a thermocouple. Upon the temperature of the heating element 38 reaching a predetermined temperature or higher, the thermocouple deforms to cut off an electric circuit. Accordingly, power supply from a non-illustrated power source is cut off.

The thermostat can favorably detect an excessive temperature increase of the heating element 38 in the present embodiment, thereby favorably cutting off power supply to the heating element 38.

As illustrated in FIG. 10A, the temperature detection section 37 has a heat sensitive part 51. The heat sensitive part 51 detects the temperature of the heating element 38. The heat sensitive part 51 has a facing surface 52 including a central part 53. The facing surface 52 is a surface of the heat sensitive part 51 that faces the heating element 38. The central part 53 is a central part of the facing surface 52.

As illustrated in FIGS. 8, 9, and 10B to 10D, the spacer 40 (spacer 41, spacer 42) is disposed between the temperature detection section 37 and the heater 32 so that the temperature detection section 37 and the heater 32 are out of contact with each other.

The spacer 41 includes a separator 44. As illustrated in FIGS. 10C and 10D, the spacer 42 includes a separator 45.

As illustrated in FIG. 10B, the separator 44 of the spacer 41 separates the temperature detection section 37 from the heating element 38, and melts upon the temperature of the heating element 38 increasing to a specific temperature or higher. The separator 45 of the spacer 42 separates the temperature detection section 37 from the heating element 38, and melts upon the temperature of the heating element 38 increasing to a specific temperature or higher as illustrated in FIG. 10C.

The separator 44 or the separator 45 is disposed between the heater 32 and the temperature detection section 37, and melts by heat of the heating element 38.

As illustrated in FIGS. 10A and 10B, the separator 44 is disposed at an end, except the central part 53, of the facing surface 52 of the heat sensitive part 51 that faces the heater 32 so that the heating element 38 and the temperature detection section 37 are out of contact with each other.

As illustrated in FIG. 10B, the separator 44 of the spacer 41 may have a frame shape surrounding the facing surface 52 of the temperature sensitive member 51, for example.

The shape of the separator 44 is not limited to that illustrated in FIG. 10B so long as the separator 44 has a shape that does not cover the central part 53 of the facing surface 52 of the heat sensitive part 51.

Alternatively, as illustrated in FIGS. 10C and 10D, the separator 45 is disposed at a location including the central part 53 of the facing surface 52 of the heat sensitive part 51 that faces the heating element 38 of the heater 32 so that the heating element 38 and the temperature detection section 37 are out of contact with each other.

As illustrated in FIG. 10C, the shape of the separator 45 of the spacer 42 may be a cross shape that covers the central part 53 of the facing surface 52 of the temperature sensitive member 51, for example.

The shape of the separator 44 is not limited to that illustrated in FIG. 10B so long as the separator 44 does not cover at least the central part 53 of the facing surface 52 of the heat sensitive part 51 as illustrated in FIG. 10D.

Absorption of heat of the heating element 38 by the temperature detection section 37 can be inhibited to suppress a temperature drop of the heating element 38 in the present embodiment.

Note that another spacer 40 can be considered that includes a possible separator that is a combination of the separator 44 in FIG. 10B and the separator 45 in FIG. 10C.

However, the area of the separator 44 in FIG. 10B and the area of the separator 45 in FIG. 10C are smaller than the area of the possible separator that is a combination of the separator 44 and the separator 45.

Therefore, the separator 44 in FIG. 10B and the separator 45 in FIG. 10C readily transfer heat of the heating element 38 to the temperature detection section 37 than the possible separator when the temperature of the heating element 38 is the specific temperature or lower.

As such, temperature unevenness in the heating element 38 can be more favorably inhibited by providing the separator 44 in FIG. 10B or the separator 45 in FIG. 10C than by providing the possible separator.

Furthermore, it may be possible that when the possible separator melts, a combined part of the possible separator, which is a combination of a part thereof corresponding to the separator 44 and a part thereof corresponding to the separator 45, is pressed by the other part of the possible separator to cause roughness of the possible separator after melting.

The separator 44 in FIG. 10B and the separator 45 in FIG. 10C is less unbalanced in area than the possible separator. This causes less roughness than the possible separator after melting.

The spacer 40 (spacer 41, spacer 42) and change of the spacer 40 (spacer 41, spacer 42) due to temperature change will be described next in detail with reference to FIGS. 12A to 13F.

FIG. 12D is a view of the facing surface 52 of the heat sensitive part 51 and the separator 44 of the spacer 40 as viewed in front of the facing surface 52 of the heat sensitive part 51 of the temperature detection section 37. FIG. 12A is a view of the heat sensitive part 51 of the temperature detection section 37 and the separator 44 of the spacer 40 in FIG. 12D as viewed from a side. The same applies to the relationship between FIGS. 12E and 12B and the relationship between FIGS. 12F and 12C.

As illustrated in FIGS. 12A and 12D, when the temperature of the heating element 38 is the specific temperature or lower, the heat sensitive part 51 of the temperature detection section 37 is separated from the heater 32 as described with reference to FIG. 10A to 10D. Accordingly, transfer of heat of the heating element 38 to the heat sensitive part 51 is inhibited, thereby suppressing temperature unevenness in the heating element 38. As a result of temperature unevenness in the heating element 38 being inhibited, fixing failure can be inhibited.

As illustrated in FIGS. 12B and 12E, when the temperature of the heating element 38 excessively increases to the specific temperature or higher, the separator 44 starts melting.

As illustrated in FIG. 12E, the melting separator 44 gradually covers the facing surface 52 of the heat sensitive part 51 from each end, except the central part 53, of the facing surface 52 toward the central part 53. As illustrated in FIG. 12B, the thickness of the separator 44 becomes thinner than the thickness of the separator 44 in FIG. 12A.

As illustrated in FIG. 12F, the separator 44 further melts to cover the facing surface 52 of the heat sensitive part 51. As illustrated in FIG. 12C, the thickness of the separator 44 becomes further thinner than the thickness of the separator 44 in FIG. 12B.

As illustrated in FIGS. 12C and 12F, the separator 44 after melting does not have a gap through which heat is transferred from the heater 32 to the temperature detection section 37. That is, the separator 44 melts to be thinner than usual and further melt to fill the gap. Accordingly, the heat sensitive part 51 can favorably detect an excessive temperature increase of the heating element 38.

FIG. 13D is a view of the facing surface 52 of the heat sensitive part 51 of the temperature detection section 37 and the separator 45 of the spacer 40 as viewed in front of the facing surface 52 of the heat sensitive part 51. FIG. 13A is a view of the heat sensitive part 51 of the temperature detection section 37 and the separator 45 of the spacer 40 in FIG. 13D as viewed from a side. The same applies to the relationship between FIGS. 13E and 13B and the relationship between FIGS. 13F and 13C.

As illustrated in FIGS. 13A and 13D, when the temperature of the heating element 38 is the specific temperature or lower, the heat sensitive part 51 of the temperature detection section 37 is separated from the heater 32 as described with reference to FIG. 10A to 10D. Accordingly, transfer of heat of the heating element 38 to the heat sensitive part 51 is inhibited, thereby suppressing temperature unevenness in the heating element 38. As a result of temperature unevenness in the heating element 38 being inhibited, fixing failure can be inhibited.

As illustrated in FIGS. 13B and 13E, upon the temperature of the heating element 38 increasing to the specific temperature or higher, the separator 45 starts melting.

As illustrated in FIG. 13E, the melting separator 45 spreads from the central part 53 to each end of the facing surface 52 of the heat sensitive part 51 to gradually cover the facing surface 52 of the heat sensitive part 51. As illustrated in FIG. 13B, the thickness of the separator 45 becomes thinner than the thickness of the separator 45 in FIG. 13A.

As illustrated in FIG. 13F, the separator 45 further melts to cover the facing surface 52 of the heat sensitive part 51. As illustrated in FIG. 13C, the thickness of the separator 45 becomes further thinner than the thickness of the separator 45 in FIG. 13B.

As illustrated in FIGS. 13C and 13F, the separator 45 after melting does not have a gap through which heat is transferred from the heating element 38 to the temperature detection section 37. That is, the separator 45 melts to be thinner than usual and further melt to fill the gap. Accordingly, the heat sensitive part 51 can favorably detect an excessive temperature increase of the heating element 38.

The heating element 38 and the temperature detection section 37 are out of contact with each other in the present embodiment. Accordingly, absorption of heat of the heating element 38 by the temperature detection section 37 can be inhibited to suppress a temperature drop of the heating element 38. Furthermore, the separator 44 does not have a gap through which heat is transferred from the heater 32 to the temperature detection section 37. Accordingly, the temperature of the heating element 38 can be favorably transferred to the heat sensitive part 51 in an excessive temperature increase of the heating element 38.

The configuration of the fixing device 16 will be further described next with reference to FIGS. 2 to 11. As illustrated in FIGS. 2 and 6, when the temperature detection section 37 detects the temperature of the heating element 38 reaching the specific temperature or higher, the power supply section 19 restricts power supply to the heating element 38.

Heat of the heating element 38 is favorably transferred to the temperature detection section 37 in an excessive temperature increase of the heating element 38 in the present embodiment. Accordingly, the temperature detection section 37 can favorably detect an excessive temperature increase of the heating element 38 and the power supply section 19 can favorably restrict power supply to the heating element 38.

As illustrated in FIG. 6, the heater holding member 33 guides the fixing belt 20 in a rotatable manner and holds the heater 32 that heats the fixing belt 20. The heater 32 is mounted on a surface of the heater holding member 33 that faces the inner circumferential surface of the fixing belt 20. The belt holding member 23 is mounted on the heater holding member 33. The frame stay metal plate 34 reinforces the heater holding member 33.

As illustrated in FIGS. 10B and 10C, the spacer 40 may include flanges 43. As illustrated in FIG. 9, the flanges 43 of the spacer 40 (spacer 41, spacer 42) are held by the heater holding member 33.

The heater holding member 33 sets the spacer 40 toward the temperature detection section 37 in the present embodiment. Accordingly, the distance between the heat sensitive part 51 and the heater 32 can be kept at a specific distance to suppress a temperature drop of the heating element 38.

The melting point of the separator 44 or the separator 45 of the spacer 40 (spacer 41, spacer 42) is equal to or lower than the heat resistance temperature of the heater holding member 33.

The separator 44 or the separator 45 of the spacer 40 melts before the temperature of the heating element 38 reaches the heat resistance temperature of the heater holding member 33 in the present embodiment. Accordingly, the heat sensitive part 51 can favorably detect the specific temperature.

Note that the temperature (melting point) at which the spacer 40 starts melting is higher than the specific temperature.

The separator 44 or the separator 45 of the spacer 40 melts upon an excessive temperature increase of the heating element 38 in the present embodiment. Accordingly, the temperature detection section 37 can favorably cuts off power supply to the heating element 38.

Furthermore, the heater holding member 33 sets the spacer 40 toward the temperature detection section 37 in the present embodiment. Accordingly, the distance between the heat sensitive part 51 and the heater 32 can be kept at a specific distance to suppress a temperature drop of the heating element 38.

As illustrated in FIGS. 4 and 6, the frame stay metal plate 34 reinforces the heater holding member 33. The frame stay metal plate 34 is a thin and long metal frame stay member. As illustrated in FIG. 3, the frame stay metal plate 34 extends in the direction of the first rotation axis L1. The frame stay metal plate 34 may be formed into a rectangular U-shape, a U-shape, or a V-shape.

For example, the frame stay metal plate 34 is set at the heater holding member 33 in a posture of inverted U-shape.

As illustrated in FIG. 11, the urging member 60 urges the temperature detection section 37 toward the heater 32. As the spacer 40 melts, the distance between the heating element 38 and the temperature detection section 37 reduces due to the urging force of the urging member 60.

The separator 44 becomes thin in an excessive temperature increase of the heating element 38 in the present embodiment. Accordingly, the temperature detection section 37 can favorably detect an excessive temperature increase of the heating element 38 with a result that power supply to the heating element 38 is cut off.

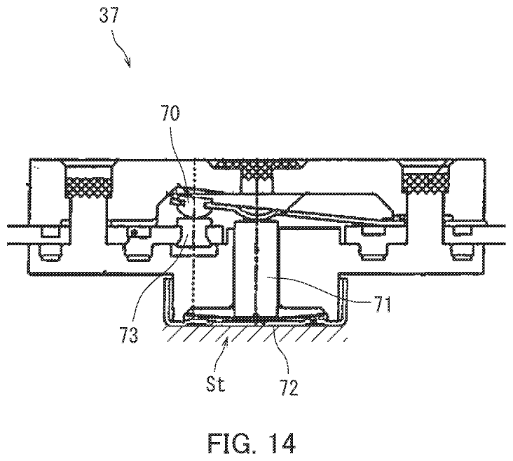

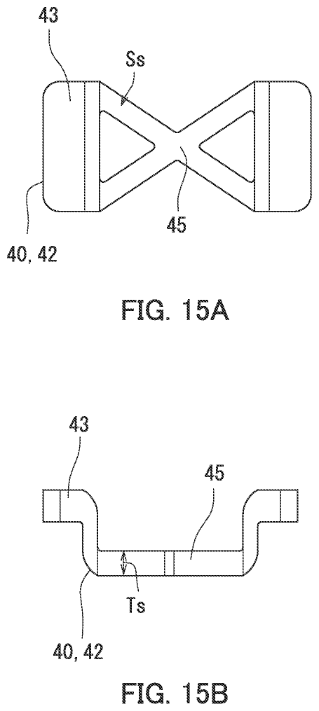

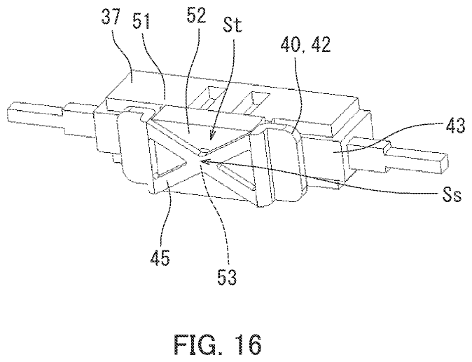

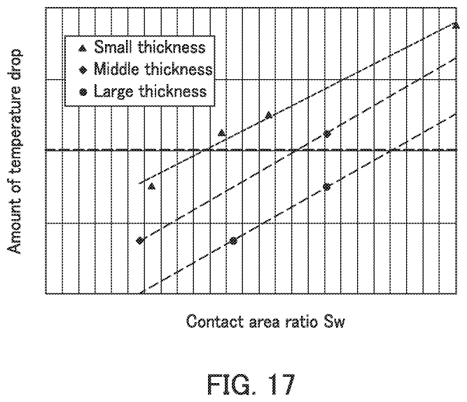

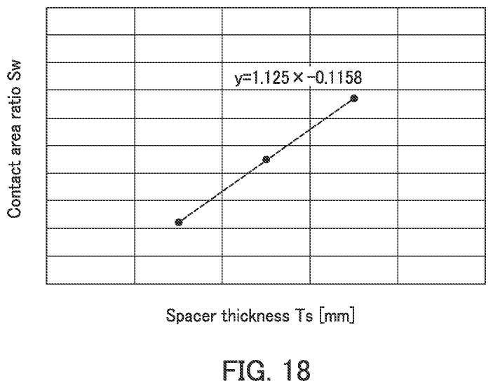

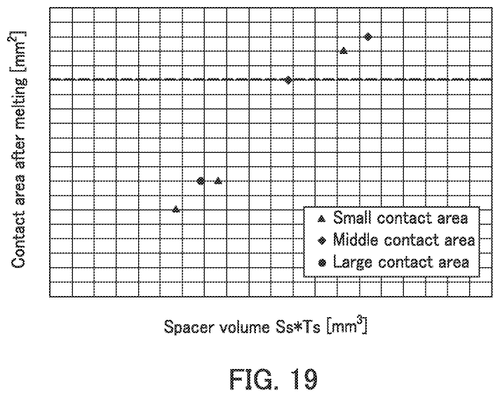

An example of the separator 44 of the spacer 40 will be described next in detail with reference to FIGS. 14 to 19. FIG. 14 is a diagram illustrating the configuration of the temperature detection section 37. FIGS. 15A and 15B each are a diagram illustrating an example of the spacer 40. FIG. 16 is a diagram illustrating the configuration of the separator 45 and the facing surface 52 of the heat sensitive part 51. FIG. 17 is a graph representation showing a relationship between a ratio Sw and the amount of temperature drop. FIG. 18 is a graph representation showing a relationship between thickness Ts of the spacer 40 and the ratio Sw. FIG. 19 is a graph representation showing a relationship between volume (Ss×Ts) (mm³) of the separator 45 and area Ss (mm²) of the separator 45 after melting.

The configuration of the temperature detection section 37 will be described first in detail with reference to FIG. 14. The temperature detection section 37 includes a contact point 70, a guide pin 71, a heat sensitive cap 72 (heat sensitive part 51 (FIG. 10A)), and a bimetal 73.

The bimetal 73 is heated via the heat sensitive cap 72. When the temperature of the bimetal 73 reaches a predetermined temperature or higher, the guide pin 71 is pushed by the bimetal 73 to separate the contact point 70 from the bimetal 73. Accordingly, power supply from a non-illustrated power source is cut off.

The hatched part in FIG. 14 corresponds to the facing surface 52 (FIG. 10A) where the heat sensitive cap 72 is in contact with the heater 32 and the spacer 40. The area of the facing surface 52 is referred to as area St (mm²).

The spacer 40 will be further described next with reference to FIGS. 15A and 15B. The spacer 40 illustrated in FIGS. 15A and 15B corresponds to the spacer 42 described with reference to FIG. 10C. The area of the separator 45 is denoted by Ss (mm²) as illustrated in FIG. 15A, and the thickness of the separator 45 is denoted by Ts (mm) as illustrated in FIG. 15B.

The relationship between the thickness Ts (mm) of the separator 45 and a ratio Sw between the area Ss (mm²) of the separator 45 and the area St (mm²) of the facing surface 52 of the heat sensitive part 51 will be described here.

As illustrated in FIG. 16, the area of the facing surface 52 of the heat sensitive part 51 is denoted by St (mm²) and the area of the separator 45 is denoted by Ss (mm²). A ratio between the area Ss (mm²) of the separator 45 and the area St (mm²) of the facing surface 52 of the heat sensitive part 51 is denoted by Sw.

The separator 44 of the spacer 40 has a large heat capacity. Therefore, when the area Ss (mm²) of the separator 44 is excessively large, the separator 44 absorbs heat of the heating element 38 in fixing operation in which the heating element 38 generates heat according to normal setting. As such, the thermal distribution of the heating element 38 becomes uneven to cause fixing failure, thereby inviting degradation of image quality.

By contrast, it is preferable that the separator 44 melts in an excessive temperature increase of the heating element 38 to fill the gap so as to cover the facing surface 52 of the heating element 38. This is because it is necessary to instantly and accurately transfer the excessive temperature increase of the heating element 38 to the heat sensitive part 51 of the temperature detection section 37.

As such, when the volume (Ss×Ts) (mm³) of the separator 44 is excessively small, the melting separator 44 insufficiently convers the facing surface 52 of the heat sensitive part 51 to insufficiently fill the gap.

Therefore, it is necessary that the volume (Ss×Ts) (mm³) of the separator 45 and the area Ss (mm²) of the separator 45 after melting are in a favorable relationship.

Description will be made next of a result of an experiment for driving the favorable relationship between the thickness Ts (mm) of the separator 45 and the ratio Sw between the area Ss (mm²) of the separator 45 and the area St (mm²) of the facing surface 52 of the heat sensitive part 51.

As illustrated in FIG. 16, the facing surface 52 of the heat sensitive part 51 has a region in contact with the heater 32 with the separator 45 of the spacer 40 therebetween and a region out of contact with the heater 32 with the gap between the spacer 40 and the heater 32. As described previously, the ratio Sw of the area of the region of the facing surface 52 of the heat sensitive part 51 that is in contact with the heater 32 with the separator 45 of the spacer 40 therebetween to the area of the facing surface 52 is expressed by ratio Sw=(area Ss (mm²))/((area St (mm²)) . . . (Expression 1).

FIG. 17 shows a relationship for each of separators 45 with different thicknesses Ts between the amount of temperature drop of the heat sensitive part 51 and the ratio Sw between the area of the region of the facing surface 52 of the heat sensitive part 51 that is in contact with the heater 32 with the separator 45 of the spacer 40 therebetween and the area of the facing surface of the heat sensitive part 51.

As illustrated in FIG. 17, a plurality of ratios Sw with respect to the amount of temperature drop of the heat sensitive part 51 were measured and plotted for respective three thicknesses Ts (small thickness, middle thickness, and large thickness).

As can be understood from FIG. 17, the ratio Sw and the amount of temperature drop is directly proportional to each other when the thickness Ts is fixed. Furthermore, the horizontal axis indicated by a broken line at the center of FIG. 17 indicates threshold at which image degradation resulting from temperature unevenness in the heating element 38 cannot be detected. It is necessary to restrict the amount of temperature drop of the heat sensitive part 51 to the threshold value or lower.

Connection between the threshold at which the center horizontal axis and the straight line for the small thickness intersect, the threshold at which the center horizontal axis and the straight line for the middle thickness intersect, and the threshold at which the center horizontal axis and the straight line for the large thickness intersect in FIG. 17 forms a linear line as shown in the graph in FIG. 18.

The linear line in FIG. 18 is expressed by for example Sw=1.125 Ts−0.1158 . . . (Expression 2). The ratio Sw preferably satisfies Sw≤1.125 Ts−0.1158 . . . (Expression 3).

When the ratio Sw and the thickness Ts falls in the relationship of Expression 3, absorption of heat of the heating element 38 by the heat sensitive part 51 of the temperature detection section 37 is inhibited in the fixing operation in which the heating element 38 generates heat according to normal setting to inhibit the thermal distribution of the heating element 38 from being uneven, thereby inhibiting degradation of image quality resulting from fixing failure.

An investigation was done into a relationship between the thickness Ts (mm) of the separator 45 and the area Ss (mm²) of the separator 45 after melting when the separator 44 melts to fill the gap in an excessive temperature increase of the heating element 38.

In FIG. 19, the horizontal axis indicates the volume (Ss×Ts) (mm³) of the separator 45 while the vertical axis indicates the area Ss (mm²) of the separator 45 after melting.

With respect to each of three areas Ss (mm²) (small contact area, middle contact area, and large contact area) of a separator 45, a plurality of volumes (Ss×Ts) (mm³) were measured and plotted for the corresponding areas Ss after melting.

FIG. 19 revealed the fact that dependencies of the thickness Ts and the area Ss are small on the area Ss (mm²) of the separator 45 after melting and depend on the volume (Ss×Ts) (mm³) of the spacer 40.

That is, it was understood that when the volume (Ss×Ts) (mm³) of the spacer 40 is fixed even with any thickness Ts and any area Ss of the separator 45, no adverse influence is given to the area Ss (mm²) of the separator 45 after melting.

The horizontal axis indicated by the broken line in FIG. 19 represents threshold of the area Ss (mm²) that is necessary to cover the facing surface 52 of the heat sensitive part 51 with the gap filled with the separator 45 after melting.

As indicated in FIG. 19, it is preferable that the ratio Sw and the thickness Ts maintain the relationship Sw≤1.125 Ts−0.1158 . . . (Expression 4). Expression 4 may be Sw≤1.13 Ts−0.12 . . . (Expression 5) with the third decimal place rounded off.

When the relationship of Expression 4 is satisfied, the melted separator 44 sufficiently covers the facing surface 52 of the heat sensitive part 51 with no gap left in an excessive temperature increase of the heating element 38.

Summation of the experimental results and consideration establishes the following conditions.

That is, the ratio Sw is equal to or smaller than (1.13 Ts (mm)−0.12) and the ratio Sw is equal to or larger than (1/(4 Ts (mm))) where St (mm²) represents the area of the facing surface 52 of the heat sensitive part 51, Ss (mm²) represents the area of the separator 45, Sw (=area Ss (mm²)/area St (mm²)) represents the ratio between the area Ss (mm²) of the separator 45 and the area St (mm²) of the facing surface 52 of the heat sensitive part 51, and Ts (mm) represents the thickness of the separator 45.

Transfer of heat of the heating element 38 to the heat sensitive part 51 is inhibited in normal operation in the present embodiment. Accordingly, temperature unevenness in the heating element 38 can be inhibited to inhibit occurrence of fixing failure. Furthermore, the separator 44 does not have the gap through which heat is transferred from the heater 32 to the temperature detection section 37. Accordingly, temperature of the heating element 38 can be favorably transferred to the heat sensitive part 51 in an excessive temperature increase.

An embodiment of the present disclosure has been described so far with reference to the drawings. However, the present disclosure is not limited to the above embodiment and can be practiced in various manners within a scope not departing from the gist of the present invention. The drawings schematically illustrate elements of configuration in order to facilitate understanding. Properties such as thickness, length, and number of each element of configuration illustrated in the drawings may differ from actual properties thereof in order to facilitate preparation of the drawings. Furthermore, properties of the elements of configuration described in the above embodiment, such as materials, shapes, and dimensions, are merely examples and are not intended as specific limitations. Various alterations may be made so long as there is no substantial deviation from the effects of the present disclosure.

What is claimed is:

1. A fixing device comprising:
a fixing belt configured to heat a sheet with a toner image formed thereon; and
a heater configured to heat the fixing belt, wherein
the heater includes:
a heating element that generates heat by energization;
a temperature detection section that is disposed out of contact with the heater and opposite to the heater and that detects a temperature of the heating element; and
a spacer disposed between the heater and the temperature detection section so that the heater and the temperature detection section are out of contact with each other,
the spacer includes a separator that separates the temperature detection section from the heater and that has a gap through which the heat is transferred from the heater to the temperature detection section and that melts upon the temperature of the heating element increasing to a specific temperature or higher, and
the separator after melting fills the gap.

2. The fixing device according to claim 1, further comprising
a power supply section configured to supply power to the heating element, wherein
when the temperature detection section detects the temperature of the heating element being the specific temperature or higher, the power supply section restricts power supply to the heating element.

3. The fixing device according to claim 1, wherein
the temperature detection section is a thermistor.

4. The fixing device according to claim 1, wherein
the temperature detection section is a thermostat that cuts off power supply to the heating element upon the temperature of the heating element reaching the specific temperature or higher.

5. The fixing device according to claim 1, wherein
the temperature detection section includes a heat sensitive part, and
the separator is disposed at an end, except a central part, of a facing surface of the heat sensitive part so that the heater and the temperature detection section are out of contact with each other, the facing surface being a surface of the heat sensitive part that faces the heater.

6. The fixing device according to claim 1, wherein
the temperature detection section includes a heat sensitive part, and
the separator is disposed at a location including a central part of a facing surface of the heat sensitive part so that the heater and the temperature detection section are out of contact with each other, the facing surface facing the heater.

7. The fixing device according to claim 1, further comprising
a heater holding member configured to hold the heater, wherein
the separator has a melting point equal to or lower than a heat resistance temperature of the heater holding member.

8. The fixing device according to claim 7, wherein
the spacer is held by the heater holding member.

9. The fixing device according to claim 1, further comprising
an urging member configured to urge the temperature detection section toward the heater, wherein
as the separator melts, a distance between the heating element and the temperature detection section reduces by urging force of the urging member.

10. An image forming apparatus comprising the fixing device according to claim 1.

11. The fixing device according to claim 1, wherein
the temperature detection section includes a heat sensitive part for temperature detection,
the separator of the spacer is located between the heater and the temperature detection section,
the separator is melted by heat of the heating element, and
where St (mm²) represents an area of a facing surface of the heat sensitive part, Ss (mm²) represents an area of the separator, a ratio between the area of the separator and the area of the facing surface of the heat sensitive part represents Sw (=Ss/St), the ratio Sw is equal to or smaller than 1.13 Ts−0.11 and equal to or larger than 1/(4 Ts), the facing surface facing the heater.

12. The fixing device according to claim 11, wherein
the temperature detection section is a thermistor.

13. The fixing device according to claim 1, wherein
the temperature detection section is a thermostat.

14. The fixing device according to claim 1, wherein
the heat sensitive part of the temperature detection section has a facing surface that faces the heater, and
the separator is disposed at an end, except a central part, of the facing surface of the heat sensitive part so that the heater and the temperature detection section are out of contact with each other.

15. The fixing device according to claim 1, wherein
the heat sensitive part of the temperature detection section has a facing surface that faces the heater, and
the separator is disposed at a central part of the facing surface of the heat sensitive part so that the heater and the temperature detection section are out of contact with each other.

16. The fixing device according to claim 1, further comprising
a heater holding member configured to hold the heater, wherein
the separator has a melting point equal to or lower than a heat resistance temperature of the heater holding member.

17. The fixing device according to claim 1, wherein
upon a temperature of the heating element reaching a predetermined temperature or higher, the temperature detection section cuts off power supply to the heating element, and
the spacer has a melting point higher than the predetermined temperature.

18. An image forming apparatus comprising the fixing device according to claim 11.
